(19) United States
(12) Patent Application Publication
(10) Pub. No.: US 2025/0346706 A1
(43) Pub. Date: Nov. 13, 2025

(54) HIGH HARDNESS THERMOPLASTIC POLYURETHANE MATERIALS HAVING GLASS TRANSITION TEMPERATURES ABOVE ROOM TEMPERATURE

(71) Applicant: Huntsman International LLC, The Woodlands, TX (US)

(72) Inventors: Bram VANROY, Tienen (BE); Hugo VERBEKE, Tienen (BE); Stef PEETERS, Tienen (BE); David BRIERS, Tienen (BE); Erika VANEMPTEN, Tienen (BE); Hanson WAN, Shanghai (CN)

(21) Appl. No.: 18/867,481

(22) PCT Filed: Jan. 30, 2023
(86) PCT No.: PCT/EP2023/052204

§ 371 Date: Nov. 20, 2024

(30) Foreign Application Priority Data
Jun. 1, 2022 (EP) 22176624.9

(51) Int. Cl. C08G 18/32; C08G 18/10

(52) U.S. Cl. CPC C08G 18/3221; C08G 18/10

(57) ABSTRACT

A reactive formulation and method for forming a thermoplastic polyurethane (TPU) having a glass transition temperature (Tg) above room temperature, preferably a Tg higher than 40° C., more preferably higher than 55° C., a flexural modulus in the range 300-15000 MPa-(measured according to ISO 178), most preferably in the range 1500-2700 MPa and a tensile strength at break (according to DIN 53504) in the range of 5 up to 150 MPa is disclosed. Said reactive formulation comprising at least an isocyanate composition and an isocyanate-reactive composition comprising at least an aromatic dicarboxylic acid based diol chain extender having a molecular weight<500 g/mol and optionally fillers.

Furthermore, a TPU material having a glass transition temperature (Tg)>room temperature and a flexural modulus in the range 300-15000 MPa (measured according to ISO 178) is disclosed which is thermally recyclable and optionally made from a terephthalic acid based polyester diol chain extender made from recycled PET.

### FIELD OF INVENTION

The present invention relates to reactive formulations and processes for making thermoplastic polyurethane materials that are easily processable, having high hardness and high flexural modulus and having a glass transition temperature above room temperature.

Furthermore, the thermoplastic polyurethane materials of the present invention have (at least partly) an amorphous structure and can be processed at temperatures below 250° C.

The thermoplastic polyurethane materials of the present invention can be easily combined with fillers and/or fibres to further enhance the strength and hardness of the thermoplastic polyurethane material and making them ideally suitable for use in composites and flooring materials.

The thermoplastic polyurethane materials of the present invention can optionally be made from sustainable products due to the fact that the reactive formulations used to make said thermoplastic polyurethane materials could contain recycled starting materials or the thermoplastic polyurethane (TPU) materials. Additionally the thermoplastic polyurethane material itself is thermally recyclable.

### BACKGROUND OF THE INVENTION

Current state of the art thermoplastic polyurethane (TPU) materials with high hardness and high flexural modulus are TPU materials with a high content of low molecular weight compounds (high hardblock content) leading to processing temperature which are often very close to the degradation temperature of the thermoplastic polyurethane materials due to the high crystallinity and/or hydrogen bond density of these TPU materials.

One of the materials that solve the issue of narrow processing window are the Isoplast® materials, such as reference material Isoplast® 301 (High hardblock TPU from Lubrizol) as described in U.S. Pat. Nos. 5,167,899 and 5,574,092A. In U.S. Pat. No. 5,574,092A the mechanism behind it is explained, which is the depolymerization at the processing temperature using an aromatic diol (the term aromatic diol used U.S. Pat. No. 5,574,092A specifically describe an aromatic or heteroaromatic moiety having two OH groups attached directly to the aromatic carbon atoms, resulting in a thermally reversible urethane bond when reacted with an isocyanate). A rigid, extrudable polyurethane material is disclosed having a specific amount of hard segments which have excellent microfiber-forming properties such as low viscosity, high melt strength and good melt elasticity when depolymerized at melt temperatures. The depolymerized polyurethane can be readily repolymerized to provide rigid polyurethane having sufficient molecular weight and desired physical and chemical properties such as toughness, chemical resistance and dimensional stability. A disadvantage of this “high degree of depolymerization” is that the polyurethane needs to be carefully processed and extremely well dried to avoid side reactions (water+isocyanate=>CO₂ formation) that cause bubbles in the processed parts (bubbles are weak spots in the final part). The extreme drying of the polymer (TPU), but also additives (e.g. plasticizers) and/or fillers (such as fibers or powders) using the depolymerization approach (as described by U.S. Pat. No. 5,574,092A) results in undesired additional costs and energy consumption.

A drawback of using 90-100 wt % hardblock materials (made using conventional chain extenders as iso-reactive compounds) without a “depolymerization mechanism” as described in U.S. Pat. No. 5,574,092A, is that they all show relatively high melting points, especially for monoethelyneglycol (MEG) and butanediol (BDO). This means that the material can only be thermoplastically processed above the melting temperature (>220-230° C.). Very often the degradation temperature of these TPU's is close to or below the melting temperature. This results in degradation of the polymer during thermal processing (especially if long exposure to temperature is required). The processing of these types of TPU's is often limited to solvent casting to avoid high temperature exposure. Solvent casting introduces not only environmental, health and safety risks (depending on the type of solvents) but also an additional energy consumption to evaporate the solvent.

In more standard high hardness TPU's a sufficient amount of high molecular weight polyols are used in combination with low molecular weight isocyanates and low molecular weight diols (chain extenders) for the preparation of TPU materials with a hardblock<70 wt %. These high molecular weight polyols are often thermally more stable (by itself) than the low molecular weight hardblock phase thereby resulting in a higher overall thermal stability of the TPU material. The flexural modulus of these materials however remains low, making them not suitable for a number of applications. Additionally the use of high molecular weight polyols often results in TPU's with a glass transition temperature below room temperature that exhibits undesirable changes in the flexural modulus at lower temperature (cold hardening). In the specific case where the used high molecular weight polyols are polyesters, the high level of ester bonds make the material more susceptible to hydrolytic degradation.

Furthermore, the industry is forced to use less petroleum-based resources and stimulate the use of recycled resources and/or produce materials which are recyclable. More in particular, for thermoplastic polyurethane (TPU) materials this could imply that the starting materials to make these thermoplastic polyurethane (TPU) materials are made from recycled materials and/or the thermoplastic polyurethane (TPU) materials itself are at least thermally recyclable without significant degradation during processing.

To solve above problems, there is a need to produce thermoplastic polyurethane (TPU) materials with high hardness and high flexural modulus which have good thermal stability and have high degradation temperatures. Ideally these thermoplastic polyurethane (TPU) materials are also thermally recyclable without significant loss in properties and are processable at temperatures below 250° C.

### AIM OF THE INVENTION

The goal is to achieve thermoplastic polyurethane (TPU) materials with high hardness (>50 Shore D, DIN ISO 7619-2) and high flexural modulus (>300 MPa, measured according to ISO 178) at room temperature, which have good thermal stability and have high degradation temperatures (temperature of 5 wt % loss measured according to ISO 11358-1 under Air condition) which is >250° C.

It is a further aim to produce thermoplastic polyurethane (TPU) materials which are processable at temperatures below 250° C. while at the same time provide a material having a glass transition temperature (Tg) above room temperature, preferably a Tg above 40° C., more preferably a Tg above 55° C.

It is a further aim to produce thermoplastic polyurethane (TPU) materials which are thermally recyclable and/or melt reprocessable after its service-life with minimal degradation (as can be expected from the good thermal stability).

It is a further goal to develop a reactive formulation suitable for making the thermoplastic polyurethane (TPU) materials according to the invention.

### Definitions and Terms

In the context of the present invention the following terms have the following meaning:
1) “NCO value” or “Isocyanate value” as referred to herein is the weight percentage of reactive isocyanate (NCO) groups in an isocyanate, modified isocyanate or isocyanate prepolymer compound.
2) The expression “Isocyanate-reactive hydrogen atoms” as used herein for the purpose of calculating the isocyanate index refers to the total of active hydrogen atoms in hydroxyl and amine groups present in the reactive compositions; this means that for the purpose of calculating the isocyanate index at the actual polymerisation process one hydroxyl group is considered to comprise one reactive hydrogen, one primary amine group is considered to comprise one reactive hydrogen and one water molecule is considered to comprise two active hydrogens.
3) The “isocyanate index” or “NCO index” or “index” as referred to herein is the ratio of available NCO-equivalents in the reactive mixture to the sum of available equivalents of isocyanate-reactive hydrogen atoms present in the reactive mixture, given as a percentage:

$$\frac{⌈ NCO ⌉ \times 100}{[ active hydrogen ]} ( \% )$$

In other words, the NCO-index expresses the percentage of isocyanate actually used in a formulation (reactive mixture) with respect to the amount of isocyanate theoretically required for reacting with the amount of isocyanate-reactive hydrogen used in a formulation (reactive mixture). In the specific case where an isocyanate prepolymer is used in the reactive mixture, it is clear that a part of the NCO-equivalents and equivalents of isocyanate-reactive hydrogen atoms is no longer available to participate in the reaction. Theses “consumed” equivalents used in the making of the isocyanate prepolymer should thus not be considered in the calculation of the isocyanate index.
4) The term “average nominal functionality of a compound” (or in short “functionality”) is used herein to indicate the number average of functional groups per molecule in a composition. It reflects the real and practically/analytically determinable number average functionality of a chemical structure. In case of the “average nominal hydroxyl functionality” (or in short “hydroxyl functionality”) it is used to indicate the number average hydroxyl functionality (number of hydroxyl groups per molecule) of the polyol or polyol composition on the assumption that it is the real and practically/analytically determinable number average functionality. This functionality is in some cases is lower than the theoretically determined functionality (number of active hydrogen atoms per molecule) of the initiator(s) sometimes used in their preparation.
5) The term “average nominal functionality of a composition” (or in short “functionality of a composition”) is used herein to indicate the number average of functional groups per molecule in a composition. It reflects the real and practically/analytically determinable number average functionality of a composition. In case of a blend of materials (isocyanate blend, polyol blend, reactive mixture) the “average nominal functionality” of the blend is identical to the “molecular number average functionality” calculated via the total number of molecules of the blend in the denominator. It thereby requires using the real and practically/analytically determinable number average functionality of each of the chemical compounds of the blend. In case of a reactive foam formulation the molecular number average functionality of the complete reactive composition should be taken into account (thus including all isocyanate and isocyanate reactive compounds.
6) The term “hardblock” refers to 100 times the ratio of the amount (in pbw) of polyisocyanate+isocyanate-reactive compounds having a molecular weight less than 500 g/mol (wherein isocyanate-reactive compounds having a molecular weight of more than 500 g/mol incorporated in the polyisocyanates are not taken into account) over the amount (in pbw) of all polyisocyanate+all isocyanate-reactive compounds used. The hardblock content is expressed in wt %.
7) The word “average” refers to number average unless indicated otherwise.
8) As used herein, the term “thermoplastic” is used in its broad sense to designate a material that is reprocessable at an elevated temperature, whereas “thermoset” designates a material that exhibits high temperature stability but without such reprocessability at elevated temperatures. Thermoset materials typically degrade before melting giving them almost no reprocessability at melting temperature.
9) The term “difunctional” as used herein means that the average nominal functionality is about 2. A difunctional polyol (also referred to as a diol) refers to a polyol having an average nominal hydroxyl functionality of about 2 (including values in the range 1.9 up to 2.1). A difunctional isocyanate refers to an isocyanate composition having an average nominal isocyanate functionality of about 2 (including values in the range 1.9 up to 2.1)
10) The term “polyurethane”, as used herein, is not limited to those polymers which include only urethane or polyurethane linkages. It is well understood by those of ordinary skill in the art of preparing polyurethanes that the polyurethane polymers may also include allophanate, carbodiimide, uretidinedione, and other linkages in addition to urethane linkages.
11) The expressions “Reaction system”, “Reactive formulation” and “Reactive mixture” are interchangeable used herein and all refer to a combination of reactive compounds used to make the thermoplastic material according to the invention wherein the polyisocyanate compounds are usually kept in one or more containers separate from the isocyanate-reactive compounds before reaction.
12) The term “room temperature” refers to temperatures of about 20° C., this means referring to temperatures in the range 18° C. to 25° C. Such temperatures will include, 18° C., 19° C., 20° C., 21° C., 22° C., 23° C., 24° C. and 25° C.
13) Unless otherwise expressed, the “weight percentage” (indicated as % wt or wt %) of a component in a composition refers to the weight of the component over the total weight of the composition in which it is present and is expressed as percentage.
14) Unless otherwise expressed, “parts by weight” (pbw) of a component in a composition refers to the weight of the component over the total weight of the composition in which it is present and is expressed as pbw.
15) Unless otherwise specified, “Shore A hardness” and “Shore D hardness” refer to the material hardness respectively measured according to DIN ISO 7619-1 and DIN ISO 7619-2.
16) “Storage modulus” is measured using dynamic mechanical thermal analysis (DMTA) according to ISO 6721 using a dual cantilever (flexural mode). It is mostly used to investigate the flexural behavior of the TPU material according to the invention in function of temperature (or in function of time at a certain temperature). The method is performed using a heating/cooling rate of 3° C./min at a frequency of 1 Hz and amplitude of 10 μm. The storage modulus is expressed in MPa.
17) “Flexural modulus” or “bending modulus” is measured according to ISO 178 and is used to investigate the flexural behavior of the TPU material according to the invention and is performing using a three-point bend test using a 65 mm support span. The flexural modulus is expressed in MPa.
18) “Flexural strength at max load” and “Flexural strain at max load” as referred to herein is measured according to ISO 178 using a support span of 65 mm and is expressed respectively in MPa and %. These properties describe the maximum load and strain which a sample can withstand in a three-point bending test before it yields or breaks.
19) “Tensile strength” and “elongation” as referred to herein are measured according to DIN 53504 and is respectively expressed in MPa and %. The test is performed using a S1 specimen type and a test speed of 100 mm/min. The Tensile strength is expressed in MPa while the elongation is expressed as a %.
20) “Glass transition temperature” and “Tg” as referred to herein refers to the temperature at which a reversible transition from a hard glass condition into a rubber-elastic condition occurs and is measured according to ISO 11357-2:2020 using differential scanning calorimetry at a heating rate of 10 K/min and analyzing the 2^{nd} heating cycle.
21) “Melt Volume Rate” and “MVR” is the rate of extrusion of a molten resin through a capillary of specified length and diameter under prescribed conditions of temperature and pressure, the rate being determined as the volume extruded over a specified time. MVR is expressed in units of cubic centimetres per 10 min (cm3/10 min) and is measured according to ISO 1133 using 5 minutes preheat time. The temperature and load mass (e.g. 8.7 kg) used during the measurement should be specified for each sample.
22) “Melting temperature”, “Melting temperature range”, “Melting point” and “Tm” as referred to herein are measured using the Melt Volume Rate since most materials according to the invention are (partially) amorphous. Often the melting temperature is a range of temperatures due to the gradual softening and flowing of the material. It can thus not be (easily) determined using differential scanning calorimetry (ISO 11357-2:2020). Alternatively the Melting temperature of the materials according to the invention are determined as the temperature at which the MVR (according to ISO 1133 using 5 minutes of preheat time) is ≥1 cm³/10 min when a load mass of 8.7 kg is used.
23) The term “difunctional polyol” refers to a polyol having an average hydroxyl functionality of about 2, preferably in the range 1.9-2.1. A difunctional polyol (diol) composition according to the present invention is not permitted to have an average hydroxyl functionality of more than 2.2 and not permitted to have an average hydroxyl functionality of less than 1.8.
24) “High Molecular weight isocyanate reactive compounds” and “high MW isocyanate reactive compounds” refer herein to isocyanate reactive compounds having a molecular weight >500 g/mol having isocyanate reactive functional group(s) and a functionality in the range 1.8 up to 2.5. Examples are polyols, amines or other isocyanate reactive compounds with a molecular weight >500 g/mol These compounds have at least 1 isocyanate reactive hydrogen atom.
25) “Low Molecular weight isocyanate reactive compounds” and “low MW isocyanate reactive compounds” refer herein to isocyanate reactive compounds having a molecular weight<500 g/mol having isocyanate reactive functional group(s) and a functionality in the range 1.8 up to 2.5. Examples are polyols, amines or other isocyanate reactive compounds with a molecular weight<500 g/mol These compounds have at least 1 isocyanate reactive hydrogen atom. The hydroxyl value and average nominal functionality can be used to calculate the number average molecular weight of certain blends of isocyanate reactive compounds.
26) “Reactive extrusion” refers to a manufacturing method that combines the traditionally separated chemical processes (polymer synthesis and/or modification) and extrusion (melting, blending, structuring, devolatilization and shaping) into a single process carried out onto an extruder. Typically, two or more liquid compositions are fed into the extruder where the material polymerizes while it is kept in the melt phase.
27) “Dicarboxylic acids” correspond to organic compounds containing two carboxyl functional groups (—COOH). The general molecular formula for dicarboxylic acids can be written as HOOC—R—COOH, where R can be aliphatic or aromatic. The most important aromatic dicarboxylic acids are phthalic, isophthalic, and terephthalic acid (for the ortho, meta, and para isomers). Terephthalic acid is used in the manufacture of the polyester known by brand names such as PET.
28) “Dicarboxylic acid based diols” refers to reaction products of dicarboxylic acids and other chemicals to form diols. Typically the dicarboxylic acids are combined with glycols to form dicarboxylic acid based diols. When the dicarboxylic acid is an aromatic dicarboxylic acid, an aromatic dicarboxylic acid based diol is formed. Recycled terephthalic acid from PET can be used in the current invention as a source for aromatic dicarboxylic acid based diols. In practice these aromatic dicarboxylic acid based diols can be both very pure products or a complex mixture of diols. In case a complex mixture of diols is made during the preparation of the aromatic dicarboxylic acid based diols, the hydroxyl value and average nominal functionality of the mixture can be used to calculate the number average molecular weight.

### DETAILED DESCRIPTION

The present invention discloses thermoplastic polyurethane (TPU) materials which have a glass transition temperature (Tg) above room temperature and have surprisingly good mechanical properties such as a high flexural modulus (>300 MPa, measured according to ISO 178) at room temperature and high hardness (>50 Shore D, DIN ISO 7619-2).

Further the TPU materials according to the invention are processable at temperatures below 250° C. and easily melt-reprocessable and recyclable after use.

The present invention discloses a method and reactive mixture for making the TPU materials according to the invention.

The use of the reactive mixture according to the invention will lead to a fully or at least partly amorphous high hardblock TPU material (hardblock >70 wt %) which gives a much broader processing window compared to state of the art crystalline high hardblock TPU materials. An amorphous TPU will enable easier processing and ultimately that easier processing gives formulators more freedom to incorporate fillers (powders, fibers, beads, . . . ). Very often the amount of filler that can be incorporated is higher for amorphous polymers due to their easier processing. The amorphous nature of the TPU material according to the invention does not result in a very broad Tg (as determined via DSC or DMA), but has a relatively sharp profile. Additionally the storage modulus plateau (measured using DMA according to ISO 6721 using flexural clamp/mode) below the glass transition temperature remains very constant over a wide range of temperatures. This leads to a good storage modulus retention below the Tg of the inventive material (ISO 6721). Compared to competitive materials such as PVC for example which already show a much faster drop in storage modulus (indication of softening) below the Tg of the material (measured using DMA according to ISO 6721 using flexural clamp/mode).

The characteristics of the TPU material according to the invention are achieved by using a reactive formulation having a hardblock content of at least 70 wt % and an isocyanate-reactive composition comprising at least an aromatic dicarboxylic acid based diol chain extender having a molecular weight<500 g/mol.

Therefore, the present invention discloses a reactive formulation for forming a thermoplastic polyurethane (TPU) having a shore D hardness (measured according to DIN ISO 7619-2) in the range 50-100 Shore D and a glass transition temperature (Tg)>room temperature, said reactive formulation comprising at least:
An isocyanate composition comprising at least one difunctional isocyanate compound, and
An isocyanate-reactive composition comprising isocyanate-reactive compounds selected from at least one aromatic dicarboxylic acid based diol chain extender having a molecular weight<500 g/mol, and
Optionally a catalyst compound, and
Optionally further additives and/or fillers
Wherein the hardblock content of the reactive formulation is >70 wt % based on the total weight of the isocyanate and isocyanate-reactive composition, the isocyanate index is in the range 75 up to 125 and the number average isocyanate functionality and/or the number average hydroxy functionality is in the range of 1.8 up to 2.5

According to embodiments, the weight % (wt %) hardblock, of the reactive formulation is >70 wt %, more preferably >75 wt %, preferably >80 wt %, more preferably >85 wt %, most preferably 90-100 wt %.

According to embodiments, the isocyanate index of the reactive foam formulation is in the range 75 up to 125, in the range 80 up to 120, in the range 85 up to 120, in the range 88 up to 120, in the range 90 up to 120, in the range 90 up to 110, in the range 92 up to 110, in the range 95 up to 110, in the range 95 up to 105, in the range 95 up to 102, in the range 95 up to 100.

According to embodiments, the number average overall functionality (hydroxy and NCO functionality) of the reactive formulation (taking into account all isocyanate compounds and isocyanate reactive compounds) is in the range of 1.8 up to 2.2, more preferably in the range of 1.9-2.1, more preferably in the range of 1.95-2.05, more preferably in the range of 1.95-2.02, more preferably in the range of 1.95-2.015, more preferably in the range of 1.95-2.012, even more preferably in the range of 1.98-2.01 and most preferably in the range of 1.98-2.005 making the TPU thermally recyclable.

According to embodiments, the number average functionality of isocyanate reactive compounds and/or isocyanate compounds and/or the complete reactive formulation (including all isocyanate and isocyanate reactive compounds) is in the range of 1.8 up to 2.5, more preferably in the range of 1.9-2.2, more preferably in the range of 1.95-2.05, more preferably in the range of 1.95-2.02, more preferably in the range of 1.95-2.015, more preferably in the range of 1.95-2.012, even more preferably in the range of 1.98-2.01 and most preferably in the range of 1.98-2.005

### The Isocyanate Reactive Composition

According to embodiments, the isocyanate-reactive composition has a number average hydroxy functionality in the range 1.8 up to 2.4 and comprising at least 10 wt % of aromatic carboxylic acid based diol chain extenders having a molecular weight<500 g/mol based on the total weight of all chain extenders in the isocyanate reactive composition

According to embodiments, the isocyanate reactive composition comprises at least 10 wt %, more preferably at least 20 wt %, more preferably at least 40 wt %, more preferably at least 50 wt %, more preferably at least 60 wt %, more preferably at least 70 wt %, more preferably at least 80 wt % aromatic dicarboxylic acid based diols having a molecular weight ≤500 g/mol based on the total weight of all chain extenders in the isocyanate reactive composition.

According to embodiments, the aromatic dicarboxylic acid based diol chain extender have a number average molecular weight (as calculated from the functionality and hydroxyl value, OH value) in the range 45 g/mol up to 500 g/mol, more preferably in the range 150 g/mol up to 500 g/mol, most preferably in the range 250 g/mol up to 500 g/mol.

According to embodiments, the aromatic dicarboxylic acid based diol chain extender has a hydroxyl value (OH value) in the range of 224 up to 1000 mg KOH/g, more preferably in the range of 224 up to 750 mg KOH, more preferably in the range of 224 up to 600 mg KOH, more preferably in the range of 224 up to 500 mg KOH, most preferably in the range of 224 up to 280 mg KOH.

According to embodiments, the aromatic dicarboxylic acid based diol chain extender is based on phthalic acid selected from o-phthalic acid, m-phthalic acid (also referred to as isophthalic acid) and/or p-phthalic acid (also referred to as terephthalic acid), more preferably the aromatic diol chain extender is based on terephthalic acid, most preferably the aromatic diol chain extender is a terephthalic acid based polyester diol chain extender.

According to embodiments, the aromatic dicarboxylic acid based diol chain extender is made using at least 1 type of glycol. More preferably the aromatic dicarboxylic acid based diol chain extender is made using at least 2 types of glycols. Most preferably the aromatic dicarboxylic acid based diol chain extender it is made using at least 3 types of glycols.

According to embodiments, the aromatic dicarboxylic acid based diol chain extender is a terephthalic acid based polyester diol chain extender made from recycled PET.

According to embodiments, the isocyanate reactive composition may comprise aromatic and aliphatic based diols such that at least 20 wt % of the diols, preferably >30 wt %, preferably >40 wt %, preferably >50 wt %, preferably >60 wt %, preferably >70 wt %, more preferably >75 wt % of the diols are selected from aromatic dicarboxylic acid based diols based on the total weight of the isocyanate reactive composition.

According to embodiments, one or more additional aliphatic chain extender(s), different from the aromatic dicarboxylic acid based diol chain extender, is present in the reactive formulation in an amount of more than 1 weight percent (>1 wt %), more preferably >2 wt %, more preferably >3 wt %, more preferably >4 wt %, more preferably >5 wt %, more preferably >6 wt %, more preferably >7 wt %, more preferably >8 wt %, more preferably >9 wt %, more preferably >10 wt % calculated on the total weight of the reactive formulation.

According to embodiments, the aromatic dicarboxylic acid based diol chain extender is made using ≤3 different types of dicarboxylic acids, more preferably using ≤2 different types of dicarboxylic acids, more preferably using 1 type of dicarboxylic acid, most preferably only using terephthalic acid.

According to embodiments, the aromatic dicarboxylic acid used to make the aromatic dicarboxylic acid based diol chain extender at least consists of 50 mol % of terephthalic acid calculated on total molar amount of the used dicarboxylic acids. More preferably the aromatic dicarboxylic acid used to make the aromatic dicarboxylic acid based diol chain extender at least consists of 60 mol % of terephthalic acid calculated on total molar amount of the used dicarboxylic acids. More preferably the aromatic dicarboxylic acid used to make the aromatic dicarboxylic acid based diol chain extender at least consists of 70 mol % of terephthalic acid calculated on total molar amount of the used dicarboxylic acids. More preferably the aromatic dicarboxylic acid used to make the aromatic dicarboxylic acid based diol chain extender at least consists of 80 mol % of terephthalic acid calculated on total molar amount of the used dicarboxylic acids. More preferably the aromatic dicarboxylic acid used to make the aromatic dicarboxylic acid based diol chain extender at least consists of 90 mol % of terephthalic acid calculated on total molar amount of the used dicarboxylic acids. More preferably the aromatic dicarboxylic acid used to make the aromatic dicarboxylic acid based diol chain extender at least consists of 95 mol % of terephthalic acid calculated on total molar amount of the used dicarboxylic acids. Most preferably the aromatic dicarboxylic acid used to make the aromatic dicarboxylic acid based diol chain extender at least consists only of terephthalic acid (100 mol %) calculated on total molar amount of the used dicarboxylic acids.

According to embodiments, the aromatic dicarboxylic acid based diol chain extender is made using ≤3 different types of dicarboxylic acids, more preferably using ≤2 different types of dicarboxylic acids, more preferably using 1 type of dicarboxylic acid, most preferably only using terephthalic acid.

According to embodiments, the aromatic dicarboxylic acid based diol chain extender has a Tg (measured according to ISO 11357-2:2020)<25° C., more preferably the Tg<20° C., more preferably the Tg<15° C., more preferably the Tg<10° C., more preferably the Tg<5° C., more preferably the Tg<0° C., more preferably the Tg<−5° C., more preferably the Tg<−10° C., more preferably the Tg<−15° C., more preferably the Tg<−20° C., more preferably the Tg<−25° C., more preferably the Tg<−30° C., more preferably the Tg<−35° C., more preferably the Tg<−40° C., more preferably the Tg<−45° C., most preferably the Tg<−50° C.

According to embodiments, the terephthalic acid based diol chain extender has a Tg (measured according to ISO 11357-2:2020)<25° C., more preferably the Tg<20° C., more preferably the Tg<15° C., more preferably the Tg<10° C., more preferably the Tg<5° C., more preferably the Tg<0° C., more preferably the Tg<−5° C., more preferably the Tg<−10° C., more preferably the Tg<−15° C., more preferably the Tg<−20° C., more preferably the Tg<−25° C., more preferably the Tg<−30° C., more preferably the Tg<−35° C., more preferably the Tg<−40° C., more preferably the Tg<−45° C., most preferably the Tg<−50° C.

According to embodiments, the difference in glass transition temperature (Tg, measured according to ISO 11357-2:2020) between the aromatic dicarboxylic acid based diol chain extender (Tg CE) and the thermoplastic polyurethane (Tg TPU) is at least 20° C., more preferably at least 30° C., more preferably at least 40° C., more preferably at least 50° C., more preferably at least 60° C., more preferably at least 70° C., more preferably at least 80° C., more preferably at least 90° C., more preferably at least 100° C., more preferably at least 110° C., more preferably at least 115° C., more preferably at least 120° C., more preferably at least 125° C., more preferably at least 130° C., more preferably at least 135° C., more preferably at least 140° C., more preferably at least 145° C., most preferably at least 150° C.

According to embodiments, the aromatic dicarboxylic acid based diol chain extender is a terephthalic acid based polyester diol chain extender made from recycled PET. The recycled content (including pre-consumer and post-consumer recycled content as defined by ISO 14021) of the terephthalic acid based polyester diol chain extender made from recycled PET is at least 5 wt %, more preferably ≥10 wt %, more preferably ≥15 wt %, more preferably ≥20 wt %, more preferably ≥25 wt %, more preferably ≥30 wt %, more preferably ≥35 wt %, more preferably ≥40 wt %, more preferably ≥45 wt %, more preferably ≥50 wt %, most preferably ≥55 wt % calculated on the total weight of the isocyanate reactive composition.

According to embodiments, the total isocyanate reactive composition (including both aromatic dicarboxylic acid based diol chain extender and possible other isocyanate reactive components) has a recycled content (including pre-consumer and post-consumer recycled content as defined by ISO 14021) of at least 2 wt %, more preferably ≥5 wt %, more preferably ≥10 wt %, more preferably 2:15 wt %, more preferably 2:18 wt %, more preferably ≥20 wt %, more preferably ≥22 wt %, more preferably ≥24 wt %, more preferably ≥26 wt %, more preferably ≥28 wt %, more preferably ≥30 wt %, more preferably ≥32 wt %, more preferably ≥34 wt %, more preferably ≥36 wt %, more preferably ≥38 wt %, most preferably ≥40 wt % calculated on the total weight of the isocyanate reactive composition.

According to embodiments, the isocyanate reactive composition comprises ≤50 wt % high molecular weight polyols having a molecular weight >500 g/mol, more preferably ≤40 wt % high molecular weight polyols having a molecular weight >500 g/mol, more preferably ≤30 wt % high molecular weight polyols having a molecular weight >500 g/mol, more preferably ≤20 wt % high molecular weight polyols having a molecular weight >500 g/mol, more preferably s10 wt % high molecular weight polyols having a molecular weight >500 g/mol, most preferably the isocyanate reactive composition contains no high molecular weight polyols.

According to embodiments, the isocyanate reactive composition comprises at least 50 wt % low molecular weight polyols having a number average molecular weight ≤500 g/mol, preferably at least 60 wt % low molecular weight polyols, preferably at least 70 wt % low molecular weight polyols, preferably at least 80 wt % low molecular weight polyols, preferably at least 85 wt % low molecular weight polyols, preferably at least 90 wt % low molecular weight polyols, preferably at least 95 wt % low molecular weight polyols calculated on the total weight of the isocyanate reactive composition. Most preferably the isocyanate reactive composition contains only low molecular weight diols ≤500 g/mol.

According to embodiments, the isocyanate reactive compounds in the reactive formulation comprises mainly low MW isocyanate reactive compounds which are selected from at least 75% by weight difunctional polyols, more preferably at least 85% by weight difunctional polyols, most preferably at least 90% by weight difunctional polyols calculated on the total weight of all isocyanate reactive compounds in the reactive formulation.

According to embodiments, the TPU material according to the invention may be fabricated using an isocyanate reactive composition which comprises mainly low molecular weight diols selected from aromatic dicarboxylic acid based diol.

According to embodiments, the TPU material according to the invention may be fabricated using an isocyanate reactive composition which comprises mainly low molecular weight difunctional polyol(s) selected from aromatic dicarboxylic acid based diol and aliphatic and/or cycloaliphatic based diols.

According to embodiments, the TPU material according to the invention contains a recycled content of ≥2 wt %, more preferably of ≥5 wt %, more preferably of ≥10 wt %, more preferably of ≥15 wt %, more preferably of ≥20 wt %, most preferably of ≥25 wt %.

According to embodiments, the low MW aliphatic based diols have a molecular weight<500 g/mol, preferably a molecular weight in the range 45 g/mol up to 500 g/mol, more preferably in the range 50 g/mol up to 250 g/mol and are selected from 1,6-hexanediol, 1,4-butanediol, monoethylene glycol, diethylene glycol, triethyleneglycol, tetraethyleneglycol, propylene glycol, dipropylene glycol, tripropylene glycol, 1,3-propanediol, 1,-3-butanediol, 1,5-pentanediol, Polycaprolactone diol, 2-methyl-1,3-propanediol, neopentyl glycol, 1,4-cyclohexanedimethanol, hydroquinone bis(2-hydroxyethyl) ether (HQEE), 1,3-Bis (2-hydroxyethyl) resorcinol (HER), ethanolamine, methyldiethanolamine and/or phenyldiethanolamine and/or combinations of two or more of these chemicals. Preferably the low MW aliphatic based diols are selected from 1,6 hexanediol, 1,4-butanediol, diethyleneglycol, 1,4-cyclohexanediol, monoethylene glycol or combinations of two or more of these chemicals.

According to embodiments, the low MW aliphatic diols have a molecular weight in the range 45 g/mol up to 500 g/mol, more preferably in the range 45 g/mol up to 400 g/mol, more preferably in the range 45 g/mol up to 300 g/mol, more preferably in the range 45 g/mol up to 250 g/mol, more preferably in the range 60 g/mol up to 200 g/mol, most preferably in the range 90 g/mol up to 150 g/mol.

According to embodiments, the isocyanate reactive composition may optionally comprise a low amount of high MW isocyanate reactive compounds having a molecular weight >500 g/mol which are selected from polyester diols, polyether diols and/or polyester polyether diols (including speciality polyester diols such as polycaprolactone or polycarbonate diols). The amount of high MW polyols in the isocyanate reactive composition should however be lower than 50 wt %, preferably lower than 40 wt %, preferably lower than 30 wt %, preferably lower than 20 wt %, preferably lower than 10 wt %, preferably lower than 5 wt %, more preferably lower than 2 wt % and most preferably lower than 1 wt % based on the total weight of all isocyanate reactive compounds in the reactive formulation.

According to embodiments, the isocyanate reactive composition may optionally comprise a low amount of high MW isocyanate reactive compounds having a molecular weight >500 g/mol which are selected from polyester diols, polyether diols and/or polyester polyether diols (including speciality polyester diols such as polycaprolactone or polycarbonate diols) having a molecular weight in the range 500 g/mol up to 10000 g/mol, preferably in the range 500 g/mol up to 5000 g/mol, more preferably in the range 650 g/mol up to 4000 g/mol. The amount of high MW polyols in the isocyanate reactive composition should however be lower than 50 wt %, preferably lower than 40 wt %, preferably lower than 30 wt %, preferably lower than 20 wt %, preferably lower than 10 wt %, preferably lower than 5 wt %, more preferably lower than 2 wt % and most preferably lower than 1 wt % based on the total weight of all isocyanate reactive compounds in the reactive formulation.

According to embodiments the reactive formulation for forming a thermoplastic polyurethane (TPU) contains less than 5 wt % of water, more preferably less than 4 wt % of water, more preferably less than 3 wt % of water, more preferably less than 2 wt % of water, more preferably less than 1 wt % of water, more preferably less than 0.5 wt % of water, more preferably less than 0.3 wt % of water, more preferably less than 0.2 wt % of water, more preferably less than 0.1 wt % of water, more preferably less than 0.05 wt % of water calculated on the total weight of the reactive formulation.

According to preferred embodiments, the reactive formulation contains no water.

### The Isocyanate Composition

According to embodiments, the isocyanate composition has an NCO value in the range 3 up to 50, preferably in the range 5 up to 33.6, more preferably in the range 10 up to 33.6, more preferably in the range 15 up to 33.6, more preferably in the range 20 up to 33.6, more preferably in the range 25 up to 33.6, most preferably in the range 30 up to 33.6.

According to embodiments, the isocyanate compounds in the isocyanate composition are selected from aromatic isocyanate compounds, comprises at least 80% by weight, at least 85% by weight, at least 90%, at least 95% by weight difunctional isocyanate compounds calculated on the total weight of all isocyanate compounds in the isocyanate composition. Most preferably the isocyanate composition contains at least 80 wt %, at least 85 wt %, at least 90 wt %, at least 95 wt %, and most preferably at least 98 wt % 4,4′-diphenylmethane diisocyanates calculated on the total weight of the isocyanate composition.

According to embodiments, the isocyanate composition used to make the TPU material according to the invention has a molecular number average isocyanate functionality in the range 1.8 up to 2.4, in the range of 1.8 up to 2.2, more preferably in the range of 1.9-2.1, more preferably in the range of 1.95-2.05, more preferably in the range of 1.95-2.02, more preferably in the range of 1.95-2.015, more preferably in the range of 1.95-2.012, even more preferably in the range of 1.98-2.01 and most preferably in the range of 1.98-2.005.

According to embodiments, the difunctional isocyanates (diisocyanates) may be selected from aliphatic diisocyanates selected from hexamethylene diisocyanate, isophorone diisocyanate, methylene dicyclohexyl diisocyanate and cyclohexane diisocyanate and or from aromatic diisocyanates selected from toluene diisocyanate (TDI), naphthalene diisocyanate, tetramethylxylene diisocyanate, phenylene diisocyanate, toluidine diisocyanate and, in particular, diphenylmethane diisocyanate (MDI).

According to embodiments, the isocyanate composition used in the process of the present invention contains essentially (at least 95% by weight, more preferably at least 98% by weight calculated on the total weight of the polyisocyanate composition) pure 4,4′-diphenylmethane diisocyanate.

According to embodiments, the isocyanate composition used in the process of the present invention contains mixtures of 4,4′-diphenylmethane diisocyanate with one or more other organic diisocyanates, especially other diphenylmethane diisocyanates, for example the 2,4′-isomer optionally in conjunction with the 2,2′-isomer.

According to embodiments, the isocyanate compounds in the polyisocyanate composition may also be an MDI variant derived from a isocyanate composition containing at least 95 wt % 4,4′-diphenylmethane diisocyanate. MDI variants are well known in the art and, for use in accordance with the invention, particularly include liquid products obtained by introducing carbodiimide groups into said polyisocyanate composition and/or by reacting with one or more polyols.

According to embodiments, the isocyanate compounds in the isocyanate composition may also be isocyanate-terminated prepolymer which is prepared by reaction of an excessive amount of the isocyanate having at least 80 wt %, at least 85 wt %, at least 90 wt %, at least 95% of 4,4′-diphenylmethane diisocyanate with a suitable difunctional polyol in order to obtain a prepolymer having the indicated NCO value. Methods to prepare prepolymers have been described in the art. The relative amounts of isocyanate and polyol depend on their equivalent weights and on the desired NCO value and can be determined easily by those skilled in the art. The NCO value of the isocyanate-terminated prepolymer is preferably above 3%, preferably above 5%, more preferably above 8% and most preferably above 10%.

According to embodiments, the difunctional isocyanate compounds in the isocyanate composition are present in the reactive formulation in an amount of more than 40 weight percent (>40 wt %), preferably >41 wt %, more preferably >42 wt %, more preferably >43 wt %, more preferably >44 wt %, more preferably >45 wt %, more preferably >46 wt %, more preferably >47 wt %, more preferably >48 wt %, more preferably >49 wt %, more preferably >50 wt % calculated on the total weight of the reactive formulation excluding any additives and fillers (if used).

According to embodiments, the aromatic isocyanate compounds in the isocyanate composition are preferably selected from difunctional diphenylmethane diisocyanates (MDI) and the difunctional MDI is present in the reactive formulation in an amount of more than 40 weight percent (>40 wt %), preferably >41 wt %, more preferably >42 wt %, more preferably >43 wt %, more preferably >44 wt %, more preferably >45 wt %, more preferably >46 wt %, more preferably >47 wt %, more preferably >48 wt %, more preferably >49 wt %, more preferably >50 wt % calculated on the total weight of the reactive formulation excluding any additives and fillers (if used).

Further Additives and/or Fillers

According to embodiments, the reactive formulation may comprise fillers such as wood chips, wood dust, wood flakes, wooden plates; paper and cardboard, both shredded or layered; sand, vermiculite, clay, cement and other silicates; ground rubber, ground thermoplastics, ground thermoset materials; honeycombs of any material, like cardboard, aluminium, wood and plastics; metal particles and plates; cork in particulate form or in layers; natural fibers, like flax, hemp and sisal fibers; synthetic fibers, like polyamide, polyolefin, polyaramide, polyester and carbon fibers; mineral fibers, like glass fibers and rock wool fibers; mineral fillers like BaSO₄ and CaCO₃; nanoparticles, like clays, inorganic oxides and carbons; glass beads, ground glass, hollow glass beads; expanded or expandable beads; untreated or treated waste, like milled, chopped, crushed or ground waste and in particular fly ash; woven and non-woven textiles; and combinations of two or more of these materials.

According to embodiments the amount of additives and/or fillers used in the TPU material according to the invention is in the range of 0-95 wt % based on the total weight of the final (filled/compounded) material.

According to embodiments the amount of additives and/or fillers used in the TPU material according to the invention is in the range of 10-60 wt % based on the total weight of the final (filled/compounded) material. More preferably the amount of additives and/or fillers is in the range of 20-50 wt % or even 30-40 wt %. In some cases the most preferred fillers are fibres or strand-like materials.

According to embodiments the amount of additives and/or fillers used in the TPU material according to the invention is in the range of 40-95 wt % based on the total weight of the final (filled/compounded) material. More preferably the amount of additives and/or fillers is in the range of 50-80 wt % or even 60-75 wt %. In some cases the most preferred fillers are powders, spheres or fine particles.

According to embodiments the amount of additives and/or fillers used in the TPU material according to the invention is >40 wt % based on the total weight of the final (filled/compounded) material. More preferably >50 wt %, more preferably >60 wt %, most preferably >70 wt %.

According to embodiments a high amount of additives and/or fillers can be used/incorporated in the TPU material due to the lower melt viscosity of the amorphous TPU material according to the invention. This higher additive and/or filler level allows to achieve superior performance over similar materials with a lower filler level. In some cases the preferred fillers to be used in high quantity are fibers, powders, spheres or fine particles.

According to embodiments, the reactive formulation may further comprise solid polymer particles such as styrene-based polymer particles. Examples of styrene polymer particles include so-called “SAN” particles of styrene-acrylonitrile. Alternatively small amounts of polymer polyols may be added as an additional polyol in the isocyanate reactive composition. An example of a commercial available polymer polyol is HYPERLITE® Polyol 1639 which is a Polyether polyol modified with a styrene-acrylonitrile polymer (SAN) with a solid content of approximately 41 wt % (also referred to as polymer polyol).

According to embodiments, other conventional ingredients (additives and/or auxiliaries) may be used in making the TPU material according to the invention. These include surfactants, flame proofing agents, fillers, pigments, stabilizers, blowing agents (including physical and chemical blowing agents), antioxidants, plasticizers, colors, processing additives (such as waxes) and the like.

According to embodiments, other polymers may be combined with the TPU material according to the invention. These include, but are not limited to, low and high density polyethylene, polypropylene, polystyrene, polytetrafluoroethylene, polyvinylchloride, polychlorotrifluoroethylene, polyamide, polyaramide, polyphenolformaldehyde, polyethyleneterephthalate, polyacrylonitrile, polyimide, aromatic polyesters and the like; and combinations of two or more of these polymers together with the TPU material.

According to embodiments, suitable catalysts accelerate in particular the reaction between the NCO groups of the diisocyanates a) and accelerate the hydroxyl groups of the isoreactive compounds and are selected from those known in the prior art such as metal salt catalysts (such as organotins, organobismuth, organozinc and the like), and amine compounds, such as triethylenediamine (TEDA), N-methylimidazole, 1,2-dimethylimidazole, N-methylmorpholine, N-ethylmorpholine, triethylamine, N,N′-dimethylpiperazine, 1,3,5-tris(dimethylaminopropyl) hexahydrotriazine, 2,4,6-tris(dimethylaminomethyl)phenol, N-methyldicyclohexylamine, pentamethyldipropylene triamine, N-methyl-N′-(2-dimethylamino)-ethyl-piperazine, tributylamine, pentamethyldiethylenetriamine, hexamethyltriethylenetetramine, heptamethyltetraethylenepentamine, dimethylaminocyclohexylamine, pentamethyldipropylene triamine, triethanolamine, dimethylethanolamine, bis(dimethylaminoethyl)ether, tris(3-dimethylamino)propylamine, or its acid blocked derivatives, and the like, as well as any mixture thereof. The catalyst compound should be present in the reactive composition in a catalytically effective amount, generally from about 0 to 5% by weight, preferably 0 to 2-% by weight, most preferably 0 to 1-% by weight, based on total weight of all reactive ingredients used.

### The Method for Making the TPU Material According to the Invention

All reactants in the reactive formulation according to the invention can be reacted at once or can be reacted in a sequential manner. By prior mixing all or part of the isocyanate-reactive compounds solutions or suspensions or dispersions are obtained. The various components used in the manufacture of the compositions of the invention can in fact be added in any order. The process can be selected from a bulk process, either batch or continuous process including a casting process and reactive extrusion process.

As an example, the process for making the TPU material according to the invention comprises at least the steps of:
i. pre-mixing the isocyanate reactive compounds, the catalyst compounds and further additives and/or fillers, and then
ii. mixing the isocyanate composition with the composition obtained in step i) to form a reactive formulation, and
iii. allowing the reactive formulation obtained in step ii) to react, and then
iv. optionally curing and/or annealing the TPU material obtained in step iii) at an elevated temperature

According to embodiments, the step of mixing of the polyisocyanate composition with the pre-mixed composition obtained in step i) to form a reactive formulation is performed using a 2-component mixing system. According to embodiments, the mixing system is a pressure mixing system. According to embodiments, the pressure mixing system is a high pressure mixing system that uses impingement to mix materials.

According to embodiments, the step of mixing of the polyisocyanate composition with the pre-mixed composition obtained in step i) to form a reactive formulation is performed using a 2-component dynamic mixing system.

According to embodiments, the step of mixing of the polyisocyanate composition with the pre-mixed composition obtained in step i) to form a reactive formulation is performed using a combination of impingement and dynamic mixing.

According to embodiments, the process for making the TPU material according to the invention is using a Castech® casting process, a batch process and/or a reactive extrusion.

According to embodiments, no external heat is preferably added to the reactive formulation, the reaction exotherm is sufficient to obtain the final structure.

According to embodiments, the step of allowing the reactive formulation obtained in step ii) to react is performed in a mould and the mould temperature may be altered to affect skin properties. Elevated mould temperature may also prevent excessive heat loss, hereby helping conversion/molecular weight build-up during polymerisation.

According to embodiments, the method for making the TPU material according to the invention is performed at an isocyanate index in the range 75 up to 125, in the range 80 up to 120, in the range 85 up to 120, in the range 88 up to 120, in the range 90 up to 120, in the range 90 up to 110, in the range 92 up to 110, in the range 95 up to 110, in the range 95 up to 105, in the range 95 up to 102, in the range 95 up to 100.

### The TPU Material According to the Invention

According to embodiments, the TPU material has a Tg >25° C., preferably a Tg >35° C. preferably a Tg >40° C., more preferably a Tg >45° C., more preferably a Tg >50° C., more preferably a Tg >55° C., most preferably a Tg >70° C.

According to embodiments, the TPU material according to the invention is having an apparent density (ISO 1183-1) in the range 300-10000 kg/m³, in the range 500-5000 kg/m³, in the range 500-2500 kg/m³, in the range 750-2500 kg/m³, in the range 900-2500 kg/m³, in the range 900-2000 kg/m³, in the range 900-1500 kg/m³, in the range 900-1300 kg/m³, in the range 1000-1300 kg/m³, in the range 1100-1300 kg/m³, measured according to ISO 1183-1.

According to embodiments, the TPU material according to the invention is having an apparent Shore D hardness (measured according to DIN ISO 7619-2) in the range of 50 up to 100, more preferably in the range 60 up to 100, more preferably in the range 70 up to 100, more preferably in the range 70 up to 90, most preferably in the range 75 up to 85

According to embodiments, the TPU material according to the invention is having an elongation (according to DIN 53504) in the range of 1 up to 500%, more preferably in the range of 1 up to 400%, more preferably in the range of 1 up to 300%, more preferably in the range of 1 up to 200%, more preferably in the range of 1 up to 100%, more preferably in the range of 1 up to 50%, most preferably in the range of 1 up to 30%.

According to embodiments, the TPU material according to the invention is having a flexural modulus (according to ISO 178) in the range of 300 up to 15000 MPa, more preferably in the range of 500 up to 12000 MPa, more preferably in the range of 800 up to 10000 MPa, more preferably in the range of 800 up to 6000 MPa, more preferably in the range of 800 up to 5000 MPa, more preferably in the range of 1200 up to 3500 MPa, most preferably in the range of 1500 up to 2700 MPa.

According to embodiments, the TPU material according to the invention is having a tensile strength at break (according to DIN 53504) in the range of 5 up to 150 MPa, more preferably in the range of 15 up to 120 MPa, more preferably in the range of 30 up to 100 MPa, more preferably in the range of 40 up to 90 MPa, most preferably in the range of 50 up to 80 MPa.

According to embodiments, the TPU material according to the invention is having a tensile strength at maximum load (according to DIN 53504) in the range of 5 up to 150 MPa, more preferably in the range of 15 up to 120 MPa, more preferably in the range of 30 up to 100 MPa, more preferably in the range of 40 up to 90 MPa, most preferably in the range of 50 up to 80 MPa.

According to embodiments, the TPU material according to the invention is made using a reactive formulation wherein the aromatic dicarboxylic acid based diol chain extender is a terephthalic acid based polyester diol chain extender made from recycled PET and said TPU material is containing a recycled content of ≥2 wt %, more preferably of ≥5 wt %, more preferably of ≥10 wt %, more preferably of ≥15 wt %, more preferably of ≥20 wt %, most preferably of ≥25 wt % based on the total weight of the TPU material (excluding any fillers). When fillers are included in the calculation of the recycled content of the TPU material, said TPU material is containing a recycled content of 21 wt %, more preferably of ≥2 wt %, more preferably of ≥3 wt %, more preferably of ≥4 wt %, most preferably of ≥5 wt %.

The TPU material according to the invention is having thermoplastic properties. The invention therefor further provides a process for recycling and/or remelting the thermoplastic polyurethane according to the invention into new applications without significantly deteriorating the thermoplastic polymer matrix compared to state of the art high flexural modulus and high hardness materials, such a high hard-block TPU's (with a low degradation temperature) or thermoset material. Compared to these materials the TPU material according to the invention can be more easily recycled and/or remelted.

According to embodiments, the remelting/recycling of the thermoplastic TPU material according to the invention is performed by a heat and/or compression process at temperatures above the melting temperature of the thermoplastic material.

According to embodiments, the remelting/recycling of the thermoplastic TPU material according to the invention is performed by a process at temperatures above the melting temperature of the thermoplastic material to recover and/or separate the TPU from any of the used fillers or fibers.

According to embodiments, the recycling of the thermoplastic TPU material according to the invention is performed by a process using a solvent or a combination of solvents.

According to embodiments, the remelting/recycling of the thermoplastic TPU material according to the invention is performed by a process using a solvent or a combination of solvents to recover and/or separate the TPU from any of the used fillers or fibers.

According to embodiments, the remelting/recycling of the thermoplastic material according to the invention is performed in an extruder at temperatures above the melting temperature of the thermoplastic material. By further addition of a blowing agent in the extruder a foamed recycled TPU foam might be achieved.

According to embodiments, the TPU material can be processed at a temperature below 250° C., preferably at a temperature<245° C., preferably at a temperature<240° C., preferably at a temperature<235° C., preferably at a temperature<230° C., preferably at a temperature<225° C., preferably at a temperature<220° C., preferably at a temperature <215° C., preferably at a temperature<210° C., preferably at a temperature<205° C., preferably at a temperature<200° C., preferably at a temperature<195° C., preferably at a temperature<190° C., preferably at a temperature<185° C., most preferably at a temperature<180° C.

According to embodiments, the TPU material can be processed by all customary methods used in the processing of thermoplastics, for example by injection moulding, extrusion, calendaring, thermoforming, roll milling, rotational moulding, sintering methods or from solution (using a suitable solvent). Processing methods without the use of solvents are most preferred.

The invention further discloses a thermally reformed material based on the thermoplastic material according to the invention.

In some cases, it is preferred to use the thermally reformed/recycled thermoplastic material in an identical application field as the original application. An example is the use of the thermoplastic material according to the invention as a composite material, in building applications, in flooring applications.

The invention is illustrated with the following examples.

### EXAMPLES

### Chemicals Used:

| | |
|---|---|
| TEROL ® 250 | Low molecular weight Terephthalic acid based |
| | diol made from recycled PET, having an OH number |
| | of 250 mg KOH/g, from Huntsman |
| MEG | monoethyleneglycol |
| Isocyanate 1 | 4,4′-MDI available as Suprasec ® 1306 from Huntsman |
| Isocyanate 2 | Low functional 4,4′-MDI based prepolymer, liquid |
| | at room temperature, available as Suprasec ® 2021 |
| | from Huntsman with an NCO content of 23.2% |
| Avalon 65DB | Commercial TPU, available from Huntsman (not using |
| | any Terephthalic acid based diols) |
| Isoplast | Commercial Engineering TPU, available from Lubrizol |
| 101 ETP | (not using any Terephthalic acid based diols) |

### Examples Described in Table 1—Sample Preparation

Comparative examples 1 and 2 (CE1 and CE2) described in table 1 are thermoplastic materials obtained from the respective suppliers and processed via injection moulding according to the supplier guidelines.

Comparative examples 3 (CE3) and Inventive example 1 (E1) are prepared via a batch process. The thermoplastic polyurethane samples are made using a Cas.Tech DB9 cast elastomer machine. The raw materials (“isocyanate blend”, “chain extender blend”, “isocyanate reactive blend”, additives) were kept at 50±1° C. on the material tanks (only in case of Isocyanate 1 a temperature of 60° C. was used for that specific material tank). In example E1, two different iso reactive materials are used which were processed using separate raw material tanks (it is however possible to obtain similar/identical results using a pre-blend of the different iso reactive materials that would be stored on a single raw material tank). The materials are mixed in the mixhead at a speed of 5000 RPM with an output of 1900 g/min. Samples are cast in a stand-up sheet mold set at a temperature of 120° C. to prepare A4 size samples with a thickness of 4 mm. The samples were demolded after curing (see demould time, table 1) to obtain the thermoplastic polyurethane material which is solid at room temperature.

The properties of the different comparative and inventive samples presented in table 1 are measured using the methods described below.

| Property | Unit | Method |
|---|---|---|
| Glass transition temperature | ° C. | measured according to ISO 11357-2: 2020 using differential |
| (Tg) | | scanning calorimetry at a heating rate of 10 K/min and |
| | | analyzing the 2^{nd} heating cycle |
| Melt volume rate (MVR) | Cm³/10 min | Measured according to ISO 1133 using 5 minutes preheat |
| | | time. The temperature and load mass (e.g. 8.7 kg) is |
| | | specified for each sample. |
| Degradation Temperature | ° C. | measured according to 11358-1 under Air condition. |
| (TGA 5 wt %) | | Temperature of 5 wt % loss of the sample is the determined |
| | | degradation temperature |
| Density | kg/m³ | Measured according to ISO 1183-1 at 23° C. |
| Hardness (Shore D) | shore D | Measured according to DIN ISO 7619-2 at 23° C. |
| Flexural stress at max load | MPa | Measured according to ISO 178 using a three-point bend |
| Flexural strain at max load | % | test with a 65 mm support span. Test performed at 23° C. |
| Flexural Modulus | MPa | |
| Tensile strength at max load | MPa | Measured according to DIN 53504 using an S1 specimen |
| Elongation at break | % | type and a test speed of 100 mm/min. Test performed at |
| | | 23° C. |
| Lowest Extrusion Processing | ° C. | Lowest Temperature at which the material can still be |
| temperature | | processed using a Haake single screw extruder. If different |
| | | temperatures are used for the different zones, the highest |
| | | temperature zone is used. |

The results in table 1 clearly demonstrate the increased shore D hardness and higher flexural modulus of the inventive TPU material (E1) over comparative example 1 (CE1) while maintaining a similar processing temperature and degradation temperature. The inventive TPU material (E1) shows similar performance (shore D hardness and higher flexural modulus) compared to comparative example 1 and 2 (CE1 and CE2) but with a lower processing temperature (see Lowest Extrusion Processing temperature). The lower processing temperature of the inventive example is additionally demonstrated using the MVR measurement of the inventive example (E1) at different temperatures below 220° C.

Example 4 (CE4) has an amount of difunctional diphenylmethane diisocyanates (MDI) in the reactive formulation which is below 40 wt % based on the total weight of the reactive formulation excluding any optional additives and fillers. CE4 contains only 35.7 wt % MDI isomers. Although the presence of aromatic carboxylic acid based diol chain extenders having a molecular weight<500 g/mol (Terol 250), the Tg of the TPU in CE4 is 34° C.

TABLE 1

| | Prop [symbol] y | unit | CE2 | CE3 | CE3 | CE4 | E1 |
|---|---|---|---|---|---|---|---|
| [symbol] | [symbol] | p [symbol] | Com [symbol] * | Com [symbol] * | [symbol] . [symbol] | [symbol] .8 | |
| [symbol] | [symbol] | p [symbol] | | [symbol] | | | [symbol] 5.83 |
| | T [symbol] | p [symbol] | | ETP | | 8 [symbol] .2 | 8 [symbol] |
| | [symbol] | p [symbol] | | | [symbol] . [symbol] | | [symbol] . [symbol] |
| | [symbol] | | | | [symbol] | | [symbol] |
| | [symbol] | [symbol] | | | [symbol] 3 | | [symbol] 3 |
| | [symbol] | [symbol] | | | 82 | 3 [symbol] . [symbol] | [symbol] .2 |
| Sample preparations | Po [symbol] ion p [symbol] | [symbol] | | | [symbol] | [symbol] | [symbol] |
| | U [symbol] time [symbol] | [symbol] | | | [symbol] | [symbol] | [symbol] |
| Thermal [symbol] and | Glass [symbol] tion [symbol] | [symbol] | [symbol] 8 | | [symbol] | [symbol] 8 | [symbol] .8 |
| pr [symbol] ing info | [symbol] /8. [symbol] g | [symbol] | | | | | [symbol] . [symbol] |
| | [symbol] /8. [symbol] g | [symbol] | | | | | [symbol] |
| | [symbol] g [symbol] T [symbol] | [symbol] | [symbol] | | [symbol] | | [symbol] |
| | [symbol] | [symbol] | [symbol] | [symbol] | [symbol] | [symbol] | [symbol] |
| Material [symbol] | Density | [symbol] g/m [symbol] | [symbol] 30 [symbol] | [symbol] 80 [symbol] 0 | 12 [symbol] 0 [symbol] | | 12 [symbol] 0 [symbol] |
| | Sh [symbol] | Sh [symbol] | [symbol] 4 | [symbol] | | | 27 |
| | [symbol] at max [symbol] | MPa | | [symbol] | | | 76 |
| | [symbol] at max [symbol] | % | | | | | [symbol] . [symbol] |
| | [symbol] | MPa | [symbol] 0 | 18 [symbol] 0 | | | [symbol] 80 |
| | [symbol] at max [symbol] | MPa | [symbol] | [symbol] | | | [symbol] 0 |
| | [symbol] at break | % | [symbol] | [symbol] | | | 2. [symbol] |

*info on the commercial complex is [symbol] from the [symbol]
**samples [symbol] below the melting temperature [symbol] without significant [symbol]
***highly [symbol] materials, [symbol] glass [symbol] the temperature range of [symbol] ° C. [symbol] 230° C. during [symbol] meas [symbol] s [symbol]
indicates data missing or illegible when filed

Below in Table 2 is an example of the temperature profile of the Haake extruder for inventive example E1. The extrusion temperature of this experiment is 200° C. (using the highest temperature zone of the extruder that is minimally required to extrude the material). This confirms that the inventive material E1 can be processed ≤220° C. and thus at significantly lower temperatures than CE1 and CE2.

TABLE 2

| Haake extruder settings | Unit | Value |
|---|---|---|
| Extruder speed | rpm | 150 |
| Temperature zone 1 | ° C. | 170 |
| Temperature zone 2 | ° C. | 195 |
| Temperature zone 3 | ° C. | 200 |
| Temperature Dye | ° C. | 170 |

The inventive example (E1) additionally has the benefit that it contains a polyol (Terol 250) made from (pre- and post-consumer) recycled material (approximately ˜55 wt % in the polyol). The recycled content of inventive example E1 is ˜22 wt % (including both pre- and post-consumer recycled materials).

1. A reactive formulation for forming a thermoplastic polyurethane (TPU) having a shore D hardness (measured according to DIN ISO 7619-2) in the range 50-100 and a glass transition temperature (Tg, measured according to ISO 11357-2:2020) above room temperature, said reactive formulation comprising at least:
An isocyanate composition comprising at least one difunctional isocyanate compound, and
An isocyanate-reactive composition comprising at least 10 wt % isocyanate-reactive compounds selected from at least one aromatic dicarboxylic acid based diol chain extender selected from terephthalic acid based polyester diol chain extender made from recycled PET having a molecular weight<500 g/mol calculated on the total weight of all chain extenders in the isocyanate reactive composition, and
Optionally a catalyst compound, and
Optionally further additives and/or fillers
Wherein the reactive formulation has a hardblock content >70 wt % based on the total weight of the isocyanate composition and isocyanate-reactive composition, the isocyanate index of the reactive formulation is in the range 75 up to 125 and the number average isocyanate functionality and the number average hydroxy functionality of the reactive formulation is in the range of 1.8 up to 2.5.

2. The reactive formulation according to claim 1, wherein the isocyanate-reactive composition has an hydroxy functionality in the range 1.8 up to 2.4 and comprising at least 20 wt % of aromatic carboxylic acid based diol chain extenders having a molecular weight<500 g/mol calculated on the total weight of all chain extenders in the isocyanate reactive composition.

3. The reactive formulation according to claim 1, wherein the TPU has a Tg.

4. The reactive formulation according to claim 1, wherein the isocyanate-reactive composition comprises aromatic and aliphatic based diols such that at least 20 wt % of the diols are selected from aromatic dicarboxylic acid based diols based on the total weight of the isocyanate reactive composition.

5. The reactive formulation according to claim 1, wherein said aromatic dicarboxylic acid based diol chain extender is based on phthalic acid selected from o-phthalic acid, m-phthalic acid and/or p-phthalic acid.

6. The reactive formulation according to claim 1, wherein the reactive formulation contains less than 1 wt % of water.

7. The reactive formulation according to claim 1, wherein the reactive formulation contains no water.

8. The reactive formulation according to claim 1, wherein the isocyanate composition comprises aromatic isocyanate compounds selected from difunctional diphenylmethane diisocyanates isomers which are present in the reactive formulation in an amount >40 wt % calculated on the total weight of the reactive formulation excluding any additives and fillers.

9. The reactive formulation according to claim 1 wherein the hardblock content of the reactive formulation is >75 wt %.

10. The reactive formulation according to claim 1, wherein the number average functionality of isocyanate-reactive compounds and/or isocyanate compounds and/or the complete reactive formulation (including all isocyanate and isocyanate-reactive compounds) is in a range of 1.8 up to 2.5.

11. The reactive foam formulation according to claim 1, wherein the isocyanate composition has an NCO value in the range 3 up to 50.

12. The reactive formulation according to claim 1, wherein the isocyanate composition is comprised of at least 80 wt % 4,4′-diphenylmethane diisocyanates calculated on the total weight of the isocyanate composition.

13. The reactive formulation according to claim 1, wherein the isocyanate index of the reactive formulation is in a range of 80 up to 120.

14. The reactive formulation according to claim 1, wherein the aromatic dicarboxylic acid based diol chain extender has a molecular weight in the range 45 g/mol up to 500 g/mol.

15. A process for making a thermally recyclable TPU made by combining and reacting the compounds of the reactive formulation according to claim 1.

16. A thermoplastic polyurethane (TPU) material made by combining and reacting the compounds of the reactive formulation according to claim 1, wherein the TPU material has a Tg>room temperature, a flexural modulus in a range of 300-15000 MPa (measured according to ISO 178) and a tensile strength at break (according to DIN 53504) in a range of 5 up to 150 MPa.

17. The TPU material according to claim 16 made using a reactive formulation wherein the aromatic dicarboxylic acid based diol chain extender is a terephthalic acid based polyester diol chain extender made from recycled PET and said TPU material comprises a recycled content of >2 wt % based on the total weight of the TPU material excluding any fillers.
